(19) United States
(12) Patent Application Publication
(10) Pub. No.: US 2019/0058784 A1
(43) Pub. Date: Feb. 21, 2019

(54) Method and devices for interconnecting two Bluetooth type systems

(71) Applicant: Richard Michael Truhill, Plano, TX (US)

(72) Inventor: Richard Michael Truhill, Plano, TX (US)

(21) Appl. No.: 15/731,866

(22) Filed: Aug. 17, 2017

(51) Int. Cl. H04M 1/60; H04W 4/00

(52) U.S. Cl. CPC H04M 1/6066; H04M 2250/02; H04W 4/008; H04M 1/6058

(57) ABSTRACT

A method for interconnecting two Bluetooth type systems with two sets of microphones and speakers, wherein microphone M1 and speaker(s) S1 are paired with a first computing device while microphone M2 and speaker(s) S2 are paired with a second computing device; however, microphone M1 and speaker(s) S2 share a first housing, while microphone M2 and speaker(s) S1 share a second housing.

### FIELD OF THE INVENTION

The present invention relates to an interconnection between two Bluetooth type systems.

### BACKGROUND OF THE INVENTION

The term “Bluetooth” is used herein generically to refer to any wireless technology for exchanging data over short distances, of which Bluetooth is considered an industry standard at this time. Bluetooth type devices are widely used. Each Bluetooth device is normally paired with a computer processing device, such as a computer, laptop, tablet, mobile phone, etc., during use. For example, a Bluetooth headset, containing a microphone and a speaker, would be paired with one cell phone. A Bluetooth type system could include one cell phone and one Bluetooth headset, which houses a microphone and one or more speakers.

The proposed invention allows two such Bluetooth type systems to be “cross-wired”, so that the microphone of one system is associated with the speaker(s) of the other, and vice-versa. For example, this would allow a program running on one cell phone to receive inputs from a first system's microphone and send outputs to a second system's speaker(s). A program running on another cell phone would receive inputs from the second system's microphone and send outputs to the first system's speaker(s). A more advanced application would have one computer processing device with the ability to run two programs simultaneously and be paired with two Bluetooth type systems, whereby two users would share the computer processing device rather than having individual cell phones, for example.

As for possible uses for the proposed invention, consider one example. In this day and age many people travel all over the world, and people frequently find themselves in areas where they cannot speak or understand the language. Also, more and more businesses are becoming international, requiring people who speak different languages to engage in business-related conversations. There are other translation devices already on the market; however, they do not always allow users to choose the program they feel provides the most accurate translation for them. Using the invention proposed herein, users are free to use the computer processing device they prefer, and they can choose from many language translation programs and applications (“apps”) available for computers and other devices. Such programs may be free-standing, that is attributes such as vocabulary and grammar are contained within the device, or they may depend on the interne or some other external connection to operate. The proposed invention allows each user to choose a combination of the device and the translation program they feel provides the most accurate translation for them. Most other systems are limited because they are stand-alone devices with the translation software built-in, or they only have the ability to translate one-way, that is from one language to another at a time. The proposed invention can utilize ordinary smartphones and allows two-way translation, wherein two users can each speak their own preferred language into a microphone and simultaneously hear a translation of the other user's language in a speaker.

The proposed invention would facilitate two people, who speak different languages, more easily communicating. Person 1 would have his phone P1 running a program translating his spoken language L1 to language L2. Person 2 would have his phone P2 running a program translating his spoken language L2 to language L1. In Bluetooth type system B1, phone P1 would be paired with microphone M1 and speaker S1. However, Microphone M1 is located in housing H1 worn by person 1, and speaker S1 is located in housing H2 worn by person 2. Microphone M1 inputs from person 1 would be sent to phone P1. Phone P1 would then send audio outputs of the translation to speaker S1 located in housing H2 worn by person 2. Meanwhile, in Bluetooth type system B2, phone P2 would be paired with microphone M2, located in housing H2 worn by person 2, and speaker S2, located in housing H1 worn by person 1. Microphone M2 inputs from person 2 would be sent to phone P2. Phone P2 would then send audio outputs of the translation to speaker S2, located in housing H1 worn by person 1. Therefore person 1 would speak and hear language L1, and person 2 would speak and hear language L2. In the advanced system, the two phones P1 and P2 would be replaced by one computer processing device, which would simultaneously run two language translation programs; while all other components would be the same.

The prior art teaches various methods and several devices for language translations using electronic devices. Among these are:

U.S. Pat. No. 8,311,798 to Joel Pedre teaches a translation method and device enabling a first individual speaking in a first language to converse with a second individual speaking in a second language different from the first language. The device includes a processor translating the first language into the second language and the second language into the first language; a headset, which is connected to the translation element either wired or wireless and which contains at least one earpiece and a microphone; a loudspeaker; and a means to select which languages are to be delivered respectively to the earpiece or to the loudspeaker.

U.S. Pat. No. 8,165,868 to James Donohoe teaches a speech translating system for translating speech from a first language to any of a set of second languages. The system includes an input unit capable of receiving the speech in a first language, a processor capable of converting the first language to the selected language, and an output unit capable of outputting the speech in the selected language.

U.S. Pat. No. 8,090,570 to Alexander Waibel and Christian Fuegen teaches a real-time speech translation system for translation of a spoken presentation, such as a lecture, a speech, a presentation, a colloquium, or a seminar, into a second language.

U.S. Application No. 20120330645 by Enrique D. Belisle and Berhanu Tassew teaches a multilingual Bluetooth headset, which is a Bluetooth equipped, hands free cellular telephone.

U.S. Application No. 20080091407 by Kentaro Furihata, Tetsuro Chino, and Satoshi Kamatani teaches a speech translating apparatus, which includes an input unit to input a speech in a first language, a speech recognizing unit to generate a first text, a translating unit to translate the first text into a second language and generate a second text, a first dividing unit to generate first phrases, a second dividing unit to generate second phrases, an associating unit which associates semantically equivalent phrases, and an outputting unit to sequentially output the associated phrases in a phrase order within the second text.

U.S. Application No. 20060282269 by Barry Galison teaches a universal translator to translate voice communication to another language and return a voice communication in the designated language. It contains a micro-chip to determine the input language and a micro-chip to determine the language of the voice output. The universal translator allows someone traveling from one county to another to change out the micro-chips based on the language of the country.

U.S. Application No. 20030115059 by Neville Jayaratne teaches a real time translator system using parallel processing of voice to text conversion and/or text translation and/or text to voice conversion, including microphones, voice to text converters, text to text translators, text to speech converters, and speakers.

U.S. Application No. 20030065504 by Jessica Kraemer and Lee Macklin teaches a system and process for providing instant translations of verbal communications, including a first device and a second device, each device being utilized by a person to communicate and receive translated verbal communications. Each device includes an input device, a database containing software and algorithms utilized to translate the verbal communication from a first language into a second language, a processor, one or more output devices; and a communications link for transmitting verbal translations from one person's device to a second person's device.

WO Application No. 2017034736 by William Lewis, Arul Menezes, Matthai Philipose, Vishal Chowdhary, John Franciscus, Marie Helmes, Stephen Hodges, and Stuart Alastair Taylor teaches a wearable speech translation device, which includes a microphone capturing two languages, wireless communication unit, and one or more loudspeakers that output the language translations to the first user and at least one other person.

None of these prior art references describe the present invention.

### SUMMARY OF THE INVENTION

To overcome the problems stated above, the present invention provides a method and devices to interconnect Bluetooth type systems.

In one embodiment, two headsets consist of housings that each contain a microphone and a speaker, wherein said microphones and speakers are cross-wired, allowing one person to input audio through one microphone into one computing device, such as a computer or a mobile phone with which said microphone is paired, while receiving audio outputs through a speaker from a second computing device with which said speaker is paired. Meanwhile, another person could simultaneously provide audio input through a second microphone, located in a second headset, to a second computing device with which said second microphone is paired, while receiving audio output through a second speaker, also located in said second headset; but said second speaker being paired with said first computing device. An example of the method and devices in action would serve as a real-time language translating system, wherein one person would speak and hear in one language, while another person would speak and hear in another language.

In another embodiment, either or both of said housings contain more than one speaker.

In another embodiment, said housings are fashioned as individual earpieces rather than headsets.

Another embodiment would include two individual earpieces for each user to provide a stereo listening experience.

In all of these embodiments, users 1 and 2 could reverse the order of translation. That is, user 1's computer processing device P1 would be paired with microphone M2 located in housing H2 worn by user 2 and speaker S2 located in housing H1 worn by user 1, such that device P1 would translate from user 2's spoken language L2 to user 1's preferred language L1, which user 1 would hear. Conversely, user 2's computer processing device P2 would be paired with microphone M1 located in housing H1 worn by user 1 and speaker S1 located in housing H2 worn by user 2, such that device P2 would translate from user 1's preferred language L1 to user 2's preferred language L2, which user 2 would hear.

In an advanced embodiment the two computer processing devices P1 and P2 would be replaced by one computer processing device running two language translation programs PD1 and PD2. Program PD1 would be paired with one user's microphone and the second user's speaker(s); while program PD2 would be paired with the second user's microphone and the first user's speaker(s).

### BRIEF DESCRIPTION OF THE DRAWINGS

FIG. 1 is a block diagram of the pairing of devices in the present invention.

FIG. 2 is a block diagram of the components of two headsets in the present invention.

FIG. 3 is a perspective diagram of a pair of headsets according to one embodiment of the present invention.

FIG. 4 is a perspective diagram of a pair of headsets according to a second embodiment of the present invention.

FIG. 5 is a perspective diagram of a pair of earpieces according to a third embodiment of the present invention.

FIG. 6 is a perspective diagram of stereo earpieces according to a fourth embodiment of the present invention.

FIG. 7 is a perspective view of the invention in use.

FIG. 8A is a block diagram of the pairing of devices in the final embodiment of the present invention.

FIG. 8B is a perspective view of the final embodiment of the present invention in use.

### DETAILED DESCRIPTION OF THE INVENTION

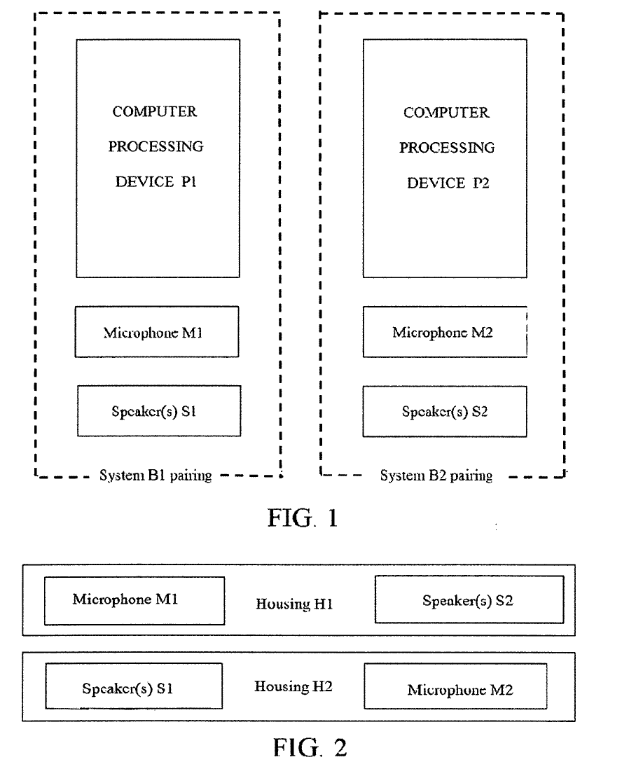

FIG. 1 is a block diagram of the pairing of devices in the present invention. The invention includes two systems. Each system includes a processing device (such as a cell phone, or computer, or laptop, or tablet, etc., or both systems can share one processing device which can simultaneously run two programs); a microphone; and one or more speakers. In system B1, one processing device P1 is paired with a set of microphone M1 and speakers(s) S1. In system B2, a second processing device P2 is paired with a second set of microphone M2 and speakers(s) S2.

FIG. 2 is a block diagram of the components of two Bluetooth headsets in the present invention. Whereas, in most Bluetooth devices the microphone and corresponding paired speaker(s) are mounted in one housing such as a headset, in the present invention said corresponding microphone and corresponding paired speaker(s) are separated and mounted in different housings. Two such sets of microphone/speaker(s) are thus “cross-wired”. Housing H1 houses microphone M1 (paired with system B1) and speaker S2 (paired with system B2); meanwhile, housing H2 houses microphone M2 (paired with system B2) and speaker S1 (paired with system B1).

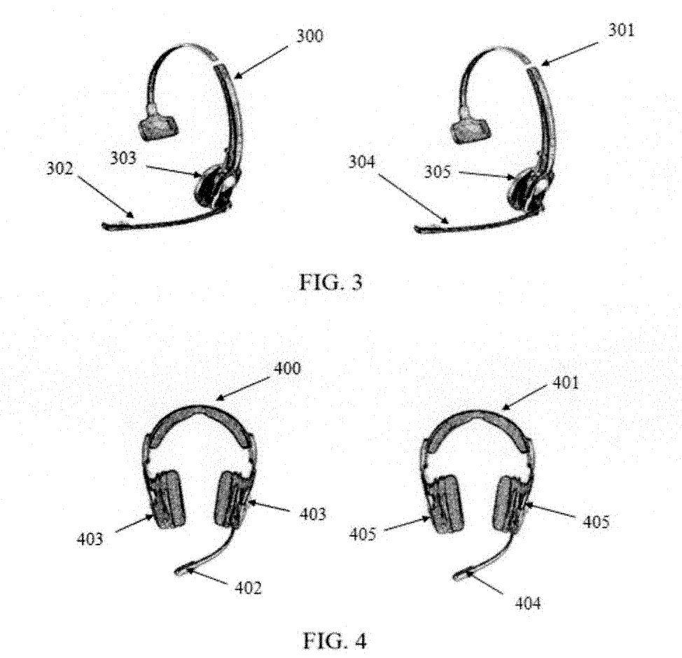

FIG. 3 is a perspective diagram of a pair of headsets according to one embodiment of the present invention. Each headset includes a housing 300 and 301 respectively, a microphone 302 and 304 respectively, and an audio output device 303 and 305 respectively. Headsets 300 and 301 are wearable on the users' bodies. Microphone 302 located in headset 300 worn by person 1 and speaker 305 located in headset 301 worn by person 2 are paired with person 1's phone, which would receive input from person 1 and send output to person 2. Microphone 304 located in headset 301 worn by person 2 and speaker 303 located in headset 300 worn by person 1 are paired with person 2's phone, which would receive input from person 2 and send output to person 1.

The audio output device(s), generally referred to herein as “speaker(s)”, may be of any design such as ear cushion(s) with speaker(s), ear bud(s), earphone(s), etc. Each housing could contain other components, such as one or more noise-cancelling microphones for example, which would not affect the proposed invention.

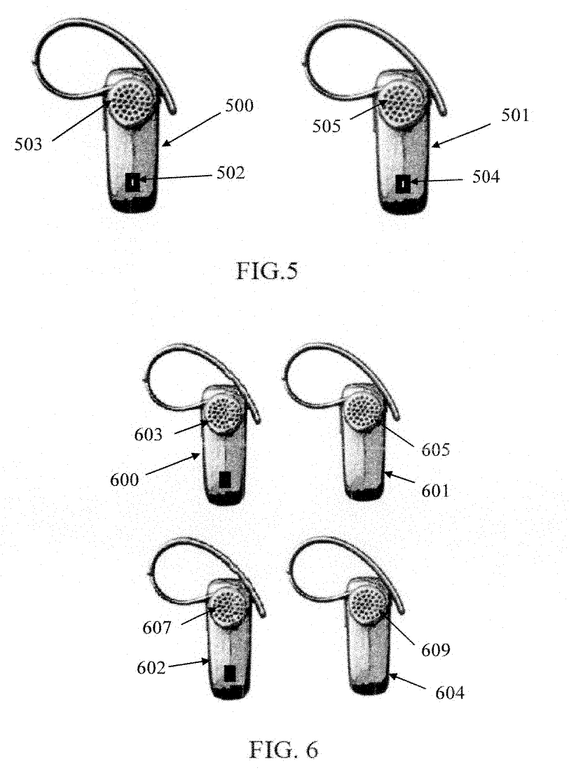

FIG. 4 is a perspective diagram of a pair of headsets according to a second embodiment of the present invention. Each headset includes a housing 400 and 401 respectively. Each headset contains a microphone 402 and 404 respectively, and two speakers 403 and 405 respectively: one speaker for each ear. Headsets 400 and 401 are wearable on the users' bodies. Microphone 402 located in headset 400 worn by person 1 and speakers 405 located in headset 401 worn by person 2 are paired with person 1's phone, which would receive input from person 1 and send output to person 2. Microphone 404 located in headset 401 worn by person 2 and speakers 403 located in headset 400 worn by person 1 are paired with person 2's phone, which would receive input from person 2 and send output to person 1.

FIG. 5 is a perspective diagram of a third embodiment of the present invention, wherein a pair of housings are fashioned as individual earpieces rather than headsets. Microphone 502 and speaker 503 are contained in earpiece 500; and microphone 504 and speaker 505 are contained in earpiece 501. Earpiece 500 can be attached to an ear of one of the users, and earpiece 501 can be attached to an ear of the other user. Microphone 502 located in earpiece 500 worn by person 1 and speaker 505 located in earpiece 501 worn by person 2 are paired with person 1's phone, which would receive input from person 1 and send output to person 2. Microphone 504 located in earpiece 501 worn by person 2 and speaker 503 located in earpiece 500 worn by person 1 are paired with person 2's phone, which would receive input from person 2 and send output to person 1.

FIG. 6 is a perspective diagram according to a fourth embodiment of the present invention showing a set of stereo earpieces. Each user is provided with stereo capability by way of two speakers 603/605 and 607/609 respectively. Housings 600 and 601 contain a pair of stereo speakers, and housings 602 and 604 contain a second set of stereo speakers. Earpieces 600 and 601 would be attached to the two ears of one user, and earpieces 602 and 604 would be attached to the two ears of the other user. Speakers 607 and 609 worn by person 2 are paired with person 1's phone, which would receive input from person 1 and send output to person 2. Speakers 603 and 605 worn by person 1 are paired with person 2's phone, which would receive input from person 2 and send output to person 1. If desired, earpieces 601 and 604 could be attached to the ear(s) of one or two additional (third and/or fourth) users.

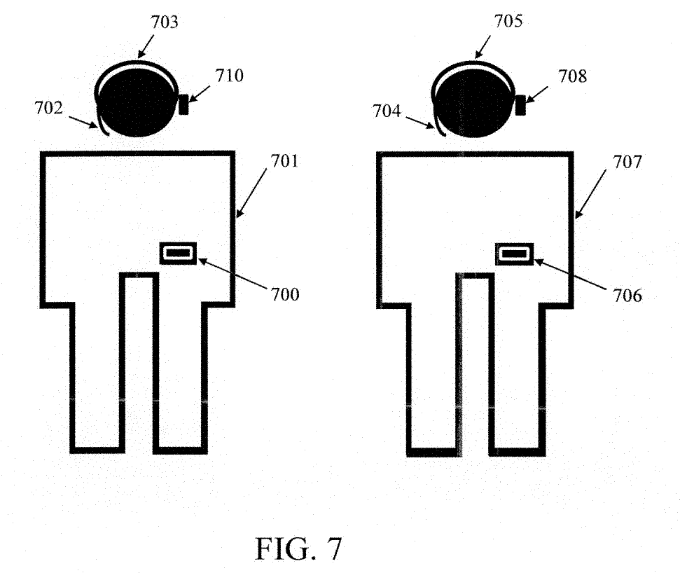

FIG. 7 is a perspective view of the present invention in use. Phone 700 of user 1 701 is paired with microphone 702 (located in housing 703) and speaker 708 (located in housing 705); and phone 706 of user 2 707 is paired with microphone 704 (located in housing 705) and speaker 710 (located in housing 703). Each phone is running a computer program, for example a language translation program. Phone 700 is set to translate from language L1 (input from microphone 702 located in housing 703) to language L2 (output to speaker 708 located in housing 705); and phone 706 is set to translate from language L2 (input from microphone 704 located in housing 705) to language L1 (output to speaker 710 located in housing 703). Therefore, user 1 701 speaks and hears language L1, and user 2 707 speaks and hears language L2.

Referring again to FIG. 7, but from a different perspective: In the description of the previous paragraph, user 1 would select a program on his phone to translate language L1 to language L2; and user 2 would select a program on his phone to translate language L2 to language L1. That is, each user would select a program to translate the language he is speaking to the language the other user is hearing. However, if the users merely exchange headsets, they can each select the program on their own phone to translate the language the other person is speaking to their own preferred language. So user 1 would select a program on his phone to translate language L2 (which user 2 is speaking) to language L1 (which user 1 would hear); and user 2 would select a program on his phone to translate language L1 (which user 1 is speaking) to language L2 (which user 2 would hear). This would be the preferred method of use for many users because they can select the translation program they feel provides the best translation of another language into their preferred language.

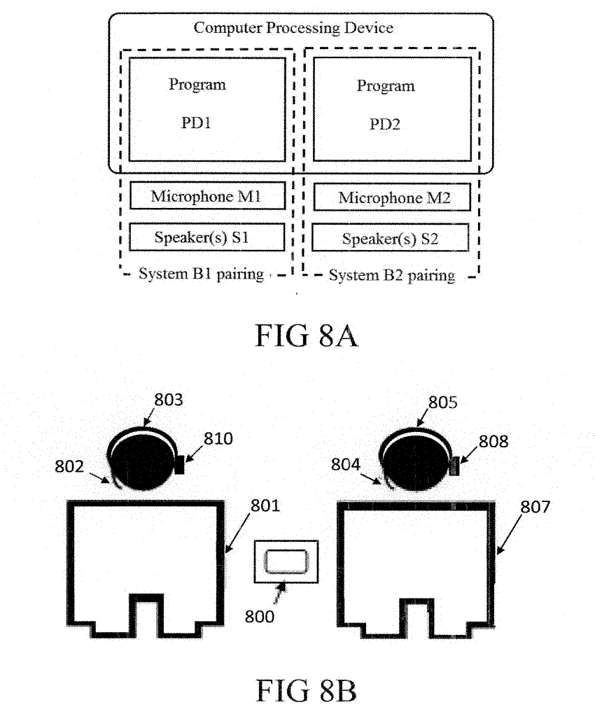

FIG. 8A is a block diagram of the pairing of devices in the final embodiment of the present invention. This embodiment includes one computer processing device which can run two programs simultaneously, wherein each program can be paired independently of the other. Each paired system includes a program, a microphone, and one or more speakers. In paired system B1, program PD1 is paired with a set of microphone M1 and speakers(s) S1. In paired system B2, a second program PD2 is paired with a second set of microphone M2 and speakers(s) S2.

FIG. 8B is a perspective view of the final embodiment of the present invention in use. One computer processing device 800 is able to run two programs simultaneously and have each program paired with a different Bluetooth type system. Program PD1, which could be a language translation program set to translate from language L1 to language L2, is paired with Bluetooth type system B1, which includes microphone 802 (located in housing 803) and speaker 808 (located in housing 805); and program PD2, which could be a language translation program set to translate from language L2 to language L1, is paired with Bluetooth type system B2, which includes microphone 804 (located in housing 805) and speaker 810 (located in housing 803). Therefore, program PD1 is set to translate from language L1 (input from microphone 802 located in housing 803) to language L2 (output to speaker 808 located in housing 805); and program PD2 is set to translate from language L2 (input from microphone 804 located in housing 805) to language L1 (output to speaker 810 located in housing 803). Therefore, user 1 801 speaks and hears language L1, and user 2 807 speaks and hears language L2.

A method and devices for interconnecting two Bluetooth type systems has been disclosed. The present invention anticipates numerous variations in the devices used. The scope of the present invention should be construed broadly and is only to be limited to that which is claimed and all equivalents. Therefore, it is understood that the above description and illustrations are exemplary of the invention and are not to be considered as limiting; and the invention is understood to include any equivalents and is not considered as limited by the above description.

What is claimed is:

1. A method for interconnecting a first Bluetooth type system with a second Bluetooth type system through wireless housings, the wireless housings including microphones and speakers, the method comprising:
A first Bluetooth type paired system further comprising:
A first computer processing device;
A first audio input device, such as a microphone;
A first audio output device, such as a speaker;
A second Bluetooth type paired system further comprising:
A second computer processing device;
A second audio input device, such as a microphone;
A second audio output device, such as a speaker;
A first housing wherein is contained the audio input device of the first Bluetooth type paired system and the audio output device of the second Bluetooth type paired system; and
A second housing wherein is contained the audio input device of the second Bluetooth type paired system and the audio output device of the first Bluetooth type paired system.

2. The method of claim 1, with the first audio output device further comprising more than one speaker.

3. The method of claim 2, wherein the second housing further contains all of the speakers of the first audio output device.

4. The method of claim 2 wherein at least one speaker of the first audio output device is in a separate housing.

5. The method of claim 1, with the second audio output device further comprising more than one speaker.

6. The method of claim 5, wherein the first housing further contains all of the speakers of the second audio output device.

7. The method of claim 5 wherein at least one speaker of the second audio output device is in a separate housing.

8. A method for interconnecting a first Bluetooth type system with a second Bluetooth type system through wireless housings, the wireless housings including microphones and speakers, the method comprising:
A computer processing device simultaneously running two computer programs;
A first Bluetooth type paired system further comprising:
A first program running on said computer processing device;
A first audio input device, such as a microphone;
A first audio output device, such as a speaker;
A second Bluetooth type paired system further comprising:
A second program running on said computer processing device;
A second audio input device, such as a microphone;
A second audio output device, such as a speaker;
A first housing wherein is contained the audio input device of the first Bluetooth type paired system and the audio output device of the second Bluetooth type paired system; and
A second housing wherein is contained the audio input device of the second Bluetooth type paired system and the audio output device of the first Bluetooth type paired system.

9. The method of claim 8, with the first audio output device further comprising more than one speaker.

10. The method of claim 9, wherein the second housing further contains all of the speakers of the first audio output device.

11. The method of claim 9 wherein at least one speaker of the first audio output device is in a separate housing.

12. The method of claim 8, with the second audio output device further comprising more than one speaker.

13. The method of claim 12, wherein the first housing further contains all of the speakers of the second audio output device.

14. The method of claim 12 wherein at least one speaker of the second audio output device is in a separate housing.
